(19) United States
(12) Patent Application Publication
(10) Pub. No.: US 2005/0237128 A1
(43) Pub. Date: Oct. 27, 2005

(54) R switch

(76) Inventor: Bernd Mayer, Muenchen (DE)

Correspondence Address: JORDAN AND HAMBURG LLP, 122 EAST 42ND STREET, SUITE 4000, NEW YORK, NY, 10168, US

(21) Appl. No.: 10/519,730

(22) PCT Filed: Jul. 11, 2003
(86) PCT No.: PCT/DE03/02343

§ 371 Date: Feb. 8, 2005

(30) Foreign Application Priority Data
Jul. 11, 2002 (DE) 102 31 559.0

(51) Int. Cl. H01P 1/10

(52) U.S. Cl. 333/106

(57) ABSTRACT

An R switch with a stator and a rotor with three paths wherein a central, straight interconnection is constructed as step transformers and formed bar-like by recesses incorporated laterally in the in the steps of the transformers in order to lower the low frequency limit of the HF signals which can be transmitted.

The invention starts outs from an R switch for switching connections between microwave waveguides on and off, as defined in the main claim.

The European patent 0 276 582 discloses such an R switch with a stator, a rotor and three interconnections constructed as step transformers. In designing the R switches known from the art, it was totally disregarded that the non-active interconnections of these switches formed short-circuited cavities, which act as cavity resonators at certain frequencies. At these frequencies, the active paths are affected so strongly, that there is practically no longer is any insulation between microwave waveguide, which are not connected, nor, with that, an error-free signal transmission. The resonance frequency of the non-active, curved paths is greater here than that of the nonactive straight interconnections, so that these two resonance frequencies limit the bandwidth of the HF signals, which can be transmitted error-free by the R switches and, with that, limit the HF signals, which can be switched through.

On the other hand, the inventive R switch, with the characterizing distinguishing features of the main claim, h as the advantage, already due to an easily realized bar-like construction of the straight interconnection, constructed as a step transformer, that it is constructed multi-stepped and that recesses are incorporated on either side of the last step of the step transformer. The inventive measure of expanding the bandwidth is easily carried out in production and can be realized inexpensively with the help of a milling machine.

According to a further, advantageous development of the invention, recesses are incorporated on either side of all steps in the step transformer of the straight interconnection, as a result of which a further lowering of the low-frequency limit of the inventive R switch is possible.

According to a further advantageous development of the invention, multi-step, bar-like constructions are formed in the step transformers of the curved paths and recesses are incorporated on either side of the last step of the step transformers.

The inventive measure of enlarging the bandwidth is easily carried out in production and can be realized inexpensively with the help of a milling machine.

According to a further, advantageous development of the invention, recesses are incorporated on either side of all steps in the step transformer of the curved paths, as a result of which a further additional lowering of the low-frequency limit of the inventive R switch is possible.

According to a further advantageous development of the invention, the straight interconnection is constructed as a step transformer, in order to save material and weight, by omitting the step transformers in the curved paths, to the extent to which this is permitted by the uncoupling.

Further advantages and advantageous developments of the invention can be inferred from the following description, the drawings and the claims.

Some examples of the invention are described in greater detail in the following and shown in the drawings in which

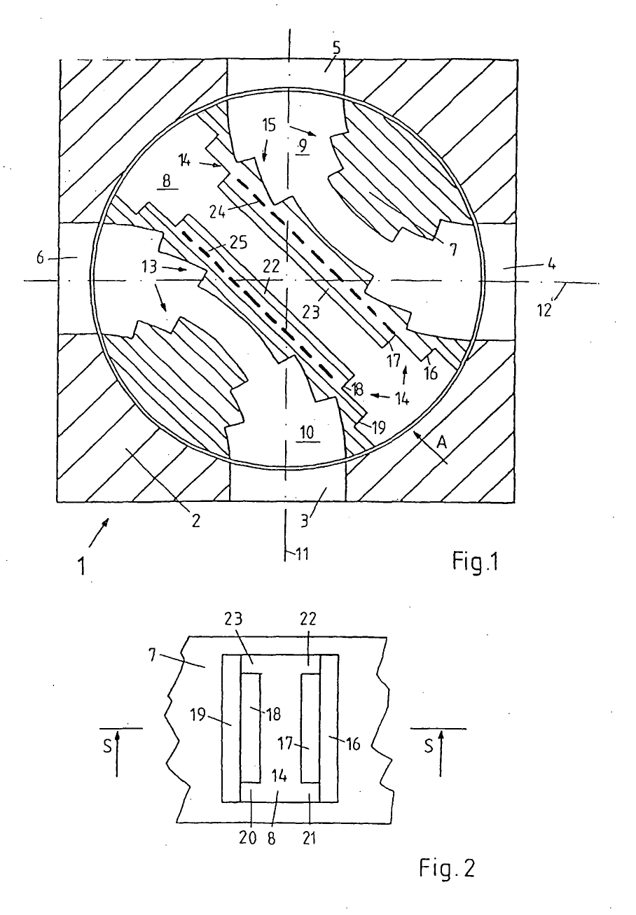

FIG. 1 is a sectional representation along the line SS in FIG. 2 through an inventive R switch with a first bar-like configuration of a step transformer in the straight interconnection of the rotor,

FIG. 2 shows a front view of the straight interconnection of the rotor of FIG. 1 in the direction A,

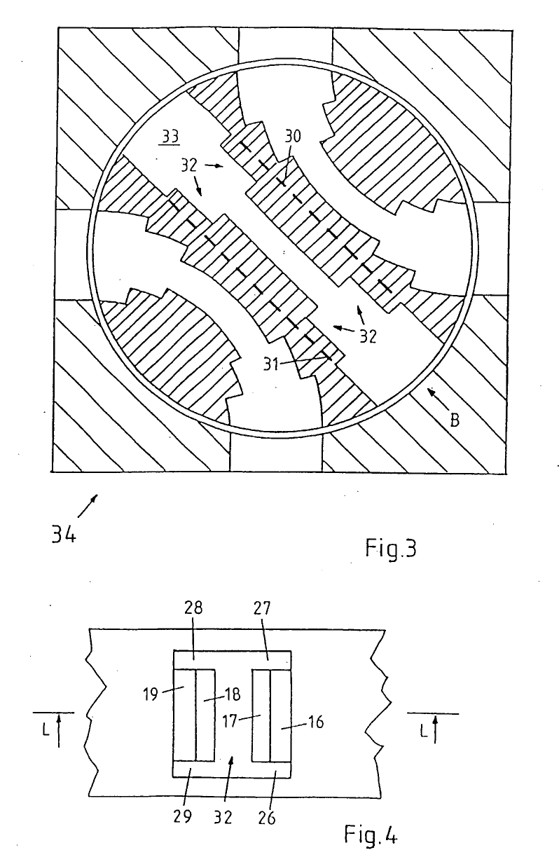

FIG. 3 shows a cross-section along the line LL of FIG. 4 through an R switch with a second bar-like configuration of the step transformer in the straight interconnection,

FIG. 4 shows a front view of the straight interconnection of the rotor of FIG. 3 in the direction B

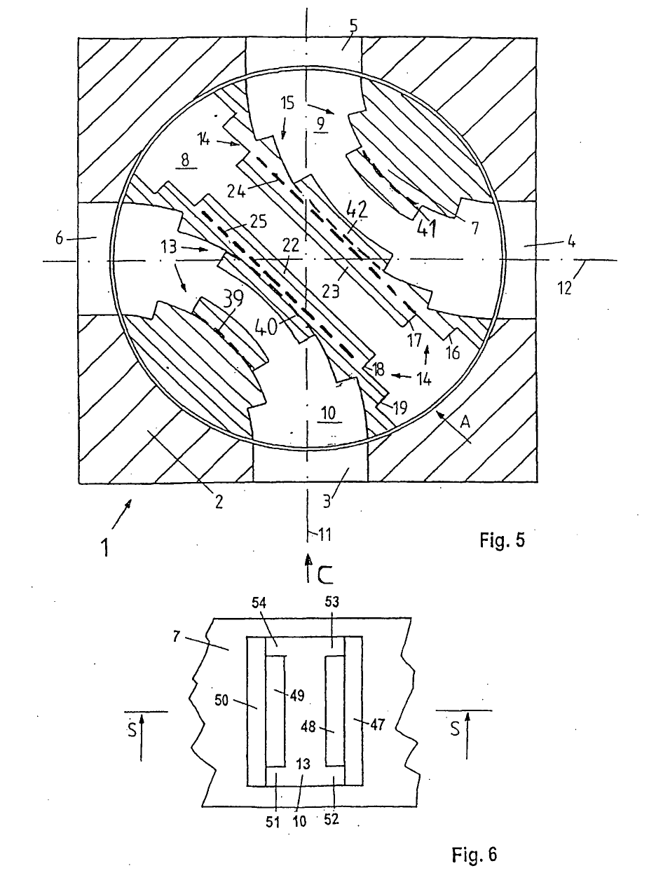

FIG. 5 shows a sectional representation along the line SS in FIG. 6 through an inventive R switch with a first bar-like configuration of a step transformer in the straight interconnection and/or the curved path of the rotor,

FIG. 6 shows a front view of the straight interconnection or the curved path of the rotor of FIG. 5 in the direction A,

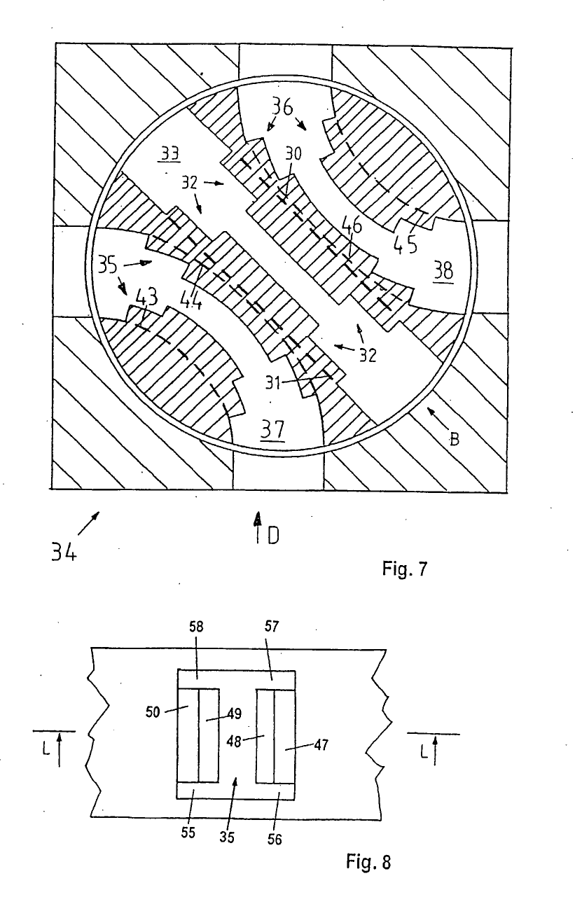

FIG. 7 shows a cross-section along the line LL in FIG. 8 through an R switch with a second bar-like configuration of the step transformer in the straight interconnection and/or curved paths,

FIG. 8 shows a front view of the straight interconnection or the curved paths of the rotor of FIG. 7 in the direction B and

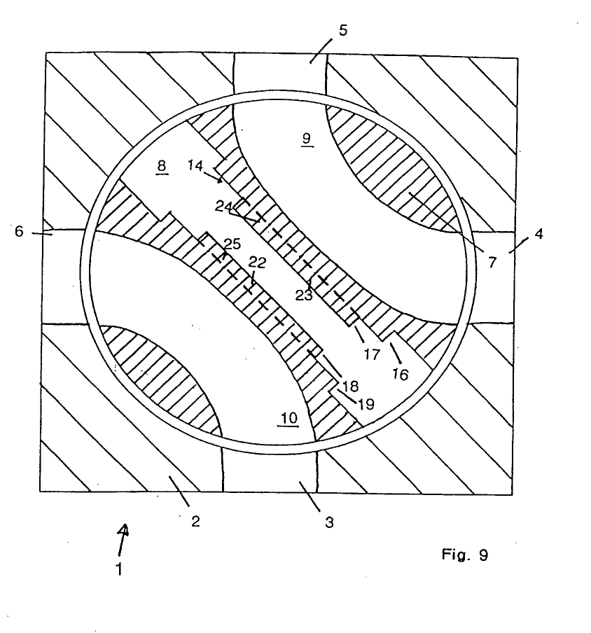

FIG. 9 shows a sectional representation along the line SS in FIG. 2 through an inventive R switch with a first bar-like configuration of a step transformer in the straight interconnection of the rotor.

FIG. 1 shows the transverse sectional representation of an R switch 1, which consists of a stator 2 with end openings 3 to 6 for connecting waveguides, which are not shown in the Figure, and of a rotor 7, which is disposed rotatably in stator 2, with a central straight interconnection 8 and, on either side thereof, “curved” paths 9 and 10, the ends of which are parallel to the axes 11 and 12, which are at right angles to one another. The axes 111 and 12 also represent orientations of the waveguides adjoining the R switch 1. Depending on the position of the rotor 7, different waveguides, attached to the openings 3 to 6 of the stator 2, are connected through. In the case of the position of the rotor 7, shown in FIG. 1, the openings 4 and 5 and the openings 3 and 6 are connected with one another. Rotating the rotor 7 clockwise through 45° connects the openings 3 and 5 with one another. If the rotor 7 is rotated clockwise by a further 45°, the waveguides, connected to the openings 5 and 6 and the waveguides, connected to the openings 3 a 4, are connected through. If the rotor 7 is rotated once again clockwise through 45°, an interconnection is created between the openings 4 and 6. If the rotor 7 is rotated further clockwise by 45°, the arrangement of FIG. 1 is obtained once again.

As far as the dimensioning of the R switch 1 perpendicularly to the plane of the drawing is concerned, the stator 2 has essentially the shape of a parallelepiped and the rotor 7 has the shape of a cylinder. In order to reduce the external dimensions of the R switch 1 as far as possible for use in satellites and space vehicles, the interconnection 8 and the paths 9 and 10 are constructed as step transformers 13, 14, 15, as a result of which especially the space required by the central parts of the interconnection 8 and the paths 9 and 10 is reduced.

As indicated in FIG. 2, the interconnection 8 as well as the paths 9 and 10 have a rectangular cross-section, so that the side walls of the step transformers 13, 14, 15 have the shape of stairsteps. The front view of the straight interconnection 8 in the direction A of FIG. 2 consequently shows the front surfaces of the steps 16 to 19 of the step transformer 14.

According to the example of the present invention, shown in FIGS. 1 and 2, the upper steps 17 and 18 of the step transformer 14 have the shape of narrow bars, which can be achieved owing to the fact that recesses 10 to 23, which are drawn in FIG. 1 by broken lines 24 and 25 as undercuts, are milled on either side of the steps 17 and 18.

In principle, a rotor switch has the disadvantage that the interconnection or path, which does not connect any stator openings with one another, acts as a cavity resonator, which is supplied with energy over the unavoidable gap between the rotor 7 and the stator 2. Accordingly, for the rotor position of FIG. 1, the straight interconnection 8 acts as a cavity resonator. Since it is brought about by these means that signals nevertheless are transmitted between the paths, which are not connected through, such as between the paths 3 and 4 or the paths 5 and 6 of the present example, the bandwidth of the signals, which can be switched through error-free by an R switch, is limited by these resonance frequencies. The lower limiting frequency is formed here by the resonance frequency of the straight interconnection 8 and the resonator frequency by the resume the frequency of the curved paths 9 and 10 (here, for example, by rotating the rotor 7 clockwise through 45°, when the paths 9 and 10 are not active).

Extensive experiments have now shown that the resonance frequency of the straight interconnection 8, acting as lower limiting frequency of the R switch 1, can very easily be decreased appreciably in order to enlarge the bandwidth of the signals, which can be transmitted error-free by the R switch 1, owing to the fact that the step transformer 14, as shown in FIGS. 1 and 2, is formed at least partially bar-shaped and that recesses 20 to 23 are milled at the side of the steps 17 and 18.

For example, in the case of a particular R switch with the name WR51 switch, which had a bandwidth of 19 to 22 GHz without the bar-like construction of the step transformer, is was possible to expand the bandwidth to 17.7 to 22 GHz in this way. This is of advantage particularly because the satellite band extends from 17.7 to 22 GHz, so that the WR51 switch, after being modified pursuant to the present invention, can be used without problems for switching signals lying within the satellite band.

A development of the inventive measure for expanding the bandwidth of an R switch is shown in FIG. 3 in section along the line LL drawn in FIG. 4 and in FIG. 4 as a plan view in the direction B of the sectional representation shown in FIG. 3. In particular, FIG. 4 shows that, contrary to FIG. 2, recesses 26 to 29 are milled not only at the sides of steps 17 and 18, but also at the sides of steps 16 and 19 from the step transformer 32. In the sectional representation of FIG. 3, this is indicated by means of broken lines 30 and 31. The advantage of this is a further lowering of the resonance frequency of the straight interconnection 33, which is inactive and acting as a cavity resonated, for example, as in FIG. 3, and, with that, a further lowering of the lower limiting frequency of the R switch 34. In other respects, the construction and mode of action of the R switch, shown in FIGS. 3 and 4, is identical with the construction and mode of action of the R switch, shown in FIGS. 1 and 2, so that these do not have to be described again.

Further developments of the inventive measure for expanding the bandwidth of an R switch are shown in FIGS. 5 to 8. The advantage of this development is the fact that the low resonance frequency of the curved paths is lowered, when these are switched inactive by a rotation of the rotor and accordingly act as cavity resonators. The construction and mode of action of the R switch, in other respects, are identical with those of the R switch of FIGS. 1 to 4.

FIG. 5 corresponds to FIG. 1 and, additionally, has recesses 51, 52, 53, 54, as shown in FIG. 6, in the steps 48, 49 in the step transformers 13, 15 in the curved paths 9, 10, which are represented in FIG. 5 by means of broken lines 39, 40, 41 and 42 as undercuts.

FIG. 7 corresponds to FIG. 3 and, additionally, has recesses 55, 56, 57, 58 as shown in FIG. 8 in the steps 47, 48, 49, 50 in the step transformers 35, 36 in the curved paths 37, 38, which are shown in FIG. 7 by means of broken lines 43, 44, 45 and 46 as undercuts.

FIG. 9 corresponds to FIG. 1; however, the curved paths 9, 10 do not contain any step transformers.

All distinguishing features, shown in the specification, the claims below and in the drawings, are inventive individually as well as in any combination with one another.

### LIST OF REFERENCE SYMBOLS

A, B direction
1 R switch
2 stator
3 to 6 opening
7 rotor
8 straight interconnection
9, 10 curved path
11, 12 axis
13, 14, 15 step transformer
16 to 19 step
20 to 23 recess
24, 25 broken line
26 to 29 recess
30, 31 broken line
32 step transformer
33 straight interconnection
34 R switch
35, 36 step transformer
37, 38 curved path
39, 40, 41, 42 broken line
43, 44, 45, 46 broken line
47, 48, 49, 50 step
51 to 54 recess
55 to 58 recess
C, D direction

1. R switch for switching connections between microwave waveguides on and off comprising:
an essentially parallelepiped stator having four side surfaces of which each have a central opening for connecting to a microwave waveguide,
a rotor disposed in the interior of a stator with its axis of rotation coaxial with the longitudinal axis of the stator and which has a centrally disposed straight interconnection and two curved paths on either side thereof,
openings of the straight interconnection and the curved paths being disposed in such a manner that, depending on the rotational position of a rotor, each opening can be connected through over the straight interconnection or over one of the curved paths to each of the other three openings,
the straight interconnection being constructed as step transformers, and
the step transformer of the straight interconnection being formed bar-like by recesses incorporated in the steps.

2. The R switch of claim 1, wherein the step transformer of the straight interconnection is constructed multi-stepped and recesses are incorporated on either side of the last step in the step transformer.

3. The R switch of claim 1, wherein the step transformer of the straight interconnection is constructed multi-stepped and recesses are incorporated on either side of all steps in the step transformer 3.

4. The R switch of claim 1, wherein the step transformer of the straight interconnection is constructed multi-stepped and the recesses are incorporated on one side of the last step in the step transformer.

5. The R switch of claim 1, wherein the step transformer of the straight interconnection is constructed multi-stepped and recesses are incorporated on one side of all steps in the step transformer.

6. The R switch for switching connections between microwave waveguides on and off comprising:
an essentially parallelepiped stator having four side surfaces each have a central opening for connecting to a microwave waveguide,
a rotor disposed in the interior of a stator with its axis of rotation coaxial with the longitudinal axis of the stator and which has a centrally disposed straight interconnection and two curved paths on either side thereof,
openings of the straight interconnection and the curved paths being disposed in such a manner that, depending on the rotational position of the rotor each opening can be connected through over the straight interconnection or over one of the curved paths to each of the other three openings,
the straight interconnection and the curved paths being constructed as step transformers, and
the step transformer of the straight interconnection being constructed multi-stepped and that recesses are incorporated on either side of the last step in the step transformer.

7. The R switch of claim 6, wherein the step transformer of the straight interconnection is constructed multi-stepped and recesses are incorporated on either side of the last step in the step transformer.

8. The R switch of claim 6, wherein the step transformer of the straight interconnection is constructed multi-stepped and recesses are incorporated on either side of all steps in the step transformer.

9. The R switch of claim 6, wherein the step transformers of the curved paths are constructed multi-stepped and recesses are incorporated on either side of the last step in the step transformers.

10. The R switch of claim 6, wherein the step transformers of the curved paths are constructed multi-stepped and recesses are incorporated on either side of all steps in the step transformers.

11. The R switch of claim 6, wherein the step transformer of the straight interconnection is constructed multi-stepped and recesses are incorporated on one side of the last step in the step transformer.

12. The R switch of claim 6, wherein the step transformer of the straight interconnection is constructed multi-stepped and recesses are incorporated on one side of all steps in the step transformer.

13. The R switch of claim 6, wherein the step transformers of the curved paths are constructed multi-stepped and recesses are incorporated on one side of the last step in the step transformers.

14. The R switch of claim 6, characterized and that the step transformers of the curved paths are constructed multi-stepped and recesses are incorporated on one side of all steps in the step transformers.
